(19) United States
(12) Patent Application Publication
(10) Pub. No.: US 2009/0182626 A1
(43) Pub. Date: Jul. 16, 2009

(54) Optimum Acquisition Valuation Systems And Methods

(76) Inventor: George W. EGAN, Cedar Grove, NJ (US)

Correspondence Address: LATHROP & GAGE LLP, 4845 PEARL EAST CIRCLE, SUITE 201, BOULDER, CO, 80301, US

(21) Appl. No.: 12/352,342

(22) Filed: Jan. 12, 2009

Related U.S. Application Data
(63) Continuation of application No. 61/020,325, filed on Jan. 10, 2008.
(60) Provisional application No. 61/020,325, filed on Jan. 10, 2008.

(51) Int. Cl. G06Q 40/00

(52) U.S. Cl. 705/10; 705/36 R

(57) ABSTRACT

A software product which is stored on computer-readable media that when executed by a computer performs steps for determining a target industry, quantifying critical mass for IPO in the industry, determining acquisition targets in the industry; and generating a three-stage offer for each target company within the acquisition targets.

### RELATED APPLICATIONS

This application claims priority to U.S. Provisional Patent Application Ser. No. 61/020,325, filed Jan. 10, 2008, the disclosure of which is incorporated herein by reference.

### BACKGROUND

Large private equity transactions traditionally back mergers and acquisitions that result in a new company with eventual access to public markets. Procedurally, the new company purchases enough revenue from target (acquired) companies with cash and stock in the new company. But, the new company must still gain critical mass and overcome numerous hurdles before gaining access to the public market. By way of example, consider the publicly traded stock NFP. Formed in January 1999 with $125 million of initial Private Equity, NFP effected seventeen acquisitions in 1999. By December 2001, NFP had completed 100 acquisitions. Still, NFP did not go public until September of 2003.

### SUMMARY

Systems and methods are disclosed to provide optimized acquisition valuations which usefully financial transactions in a “roll up”. A roll-up, as used herein, involves legal and financial combination of two or more companies (or parts of companies) into a new and generally larger company. This new company (illustratively hereinafter called “NewCo”) then seeks access to public markets as a publicly traded company, which offers liquidity and opportunity to more effectively and profitably acquire more companies in targeted industry.

These systems and methods employ RCM (Rapid Critical Mass) defined by the following six steps (see also intermittent stages) leading to initial public offering (IPO):
1) Determine industry
2) Quantify critical mass for IPO in that industry with investment banks.
3) Determine acquisition targets in the industry
4) Generate three-stage offer for each company within the acquisition targets
   First stage (achieved when there is optioned critical mass achieved).
   Second stage (achieved when NewCo begins operations as revenue neutral company).
5) Organize operating NewCo as revenue neutral to target companies
   Third option stage (occurs when NewCo signs letter of intent to go public).
6) IPO

The RCM steps are now described. In step one, an industry is determined as a set of individual companies. Step one may be automated for example by collecting online data representing industries and number of companies under a certain size (e.g., each company having less than about $20 million in sales); generally there should be hundreds of candidate companies in order to be part of a viable set within RCM. This industry is determined such that (a) all (or at least a majority) of the companies are profitable and (b) when these companies are combined, the resulting set is sufficiently large, e.g., >$10 billion. This set of companies is then the candidate “roll-up” company NewCo. Illustratively, an example candidate roll-up company, if processed through RCM, would have been National Financial Partners (symbol: NFP), which rolled up a plurality of small firms in the insurance sales, financial advisory and wealth management businesses. Another example industry that would have been suitable for RCM is the funeral home business.

In step two, critical mass is quantified. Step two may be automated by online collection of trend information (e.g., moving average of last few years) for IPOs, for example taking into account size of revenue, cash flow and earnings and other factors. This quantification is useful for IPO discussions with investment banks. Critical mass for an IPO can be market dependent on several variables. For example, a company with a website in 1998 and $0 in revenue might have been a successful IPO candidate, but whether it can reach critical mass still depends on a number of variables, including: how big and profitable must the company be to successfully sell it to the public within current market environment; and can investment bankers collect enough fees to make it worthwhile for their firm. With this critical mass, step two can thus also form an outline of the target industry, with projected revenues, profits and cash flow and economies of scale of NewCo. This outline is usually sufficient for an investment bank to provide an estimate of the scale of revenues needed to reasonably pursue an IPO: since investment banks receive about 7% of IPO sale, the system and method of the present disclosure works backward from recent deal sizes of all firms in order to make the estimate.

In step three, target acquisition companies in the industry are determined. First, a substantial percentage companies in the industry are determined and collected into an analysis set. Then the set is made smaller by taking out certain companies from the set. For example, any company in the set that is large enough to contemplate its own IPO in the foreseeable future is not an acquisition target. Second, companies in the set are rated according to profitability, years in business, size and experienced management (that is, a 30 year old company with $20M in sales, 30% profitability and seasoned 20 year executives is rated more highly than a 20 year company with $10M in sales, 28% profitability and 15 year seasoned executives). Third, each company is rated relative to other companies of the set for factors such as geographic diversity, product diversity and reputation. Fourth, companies with the lowest ratings may be culled from the analysis set.

The output from steps one, two and three enable generation of a three-stage offer for remaining companies in the acquisition set, in step four. This offer contemplates uncertain risks for each target company (illustratively labeled TC1, TC2, TC3 . . . ) as well as NewCo. Illustratively, a simplified one-page offer for one target company TC may comprise this general form:
Due to risks for both the acquirer (NewCo) and acquiree TC incurred during the stages of development prior to an IPO, NewCo is employing RCM (rapid critical mass) methodology. RCM has identified your industry and your firm within that industry as potentially benefiting from a contract with NewCo. Further, RCM has evaluated the marketplace value for both the proposed public company, NewCo and for TC. Consequently, RCM has generated the following offer to mitigate many risks (time, capital, reputation, valuation etc.) to both parties. NewCo agrees to pay TC $______ for the exclusive right to purchase ______% of the gross revenues of TC with public stock in NewCo controlled by NewCo, at a price to be determined by public markets after IPO of NewCo. Prior to any of three individual stages of the development of NewCo to a public company, TC may refund to NewCo the original $______, plus interest, and have no further obligations other than that of confidentiality. Briefly, the three stages proposed by RCM systems and methods are:
   Stage 1: Offerings to all target companies are completed.
   Stage 2: NewCo begins revenue neutral operations. Essentially, in Stage 2, NewCo begins operations confident that NewCo is both large and profitable enough to access the public markets after successfully operating the Company for a brief period. During this period TC will share proportionally in the profits of the NewCo.
   Stage 3: NewCo signs letter of intent to launch an IPO. TC will receive a proportional share of NewCo based on its revenues as a percentage of the total revenues of the NewCo, after the effect of the ownership interest of NewCo investors and management (X%).

The generation of the three-stage letter and receipt or acceptance by the TCs thus represents stage one.

Without employing RCM, NewCo and the acquired companies have considerable risk until critical mass for IPO is achieved. Accordingly, RCM addresses this risk by, in part, reducing the amount of required capital; this effectively negates risk for target companies, reduces time to critical mass and improves return on investment (ROI).

After step four, optioned critical mass is achieved (stage one); this is a milestone for option stages wherein RCM offers a three-stage option to target companies. Specifically, in stage one, NewCo offers to pay a target company for the three-stage option; the target company may opt out at any stage by repaying the option premium. In stage one, NewCo also shows other target companies that an accepting target company has accepted stage one of the option. Stage one completes when enough target companies have accepted the first stage option to achieve critical mass for an envisioned IPO. Each and every TC has the right to back out at the end of any stage. Any target company may opt out of its option within stage one and refund the option premium to NewCo.

In stage two, once sufficient critical mass is optioned, NewCo begins operating for the first year as a revenue-neutral entity. During this stage, NewCo attracts a full management team, develops systems, adds sales staff and accomplishes any other task necessary to be a viable public entity. The systems and sales staff are important economies of scale that NewCo offers to the TC. Accordingly, in step five, each target company is paid back all (or a major portion of) revenues optioned by NewCo; each TC thus contributes its percentage of revenue to the NewCo and receives in return a proportionate share of the revenues of the NewCo (currently in the form of a Master Limited Partnership, which is treated as a partnership for tax purposes) Step five may be automated, at least in part, through accounting software.

In stage three, NewCo (as MLP) signs a letter of intent to commence an IPO. In step six, an IPO commences once NewCo obtains sufficient revenues and operating history. Sufficient operating history may be automatically quantified in a detailed rights offering to the target companies. Sufficient revenues may be quantified by recent IPO history, e.g., by quantifying operating revenues and profits or firms going public of the last 12, 24 and 36 month periods. Any TC can back out prior to the IPO.

RCM thus allows target companies to operate without risk up to an IPO. RCM also allows initial investors in the roll-up (NewCo) to reduce capital requirements, and therefore risk. The use of options enables RCM to succeed, by readying a group of companies (target companies) in a targeted industry for organization into NewCo. When the options are executed, NewCo immediately has the critical size needed to access the public markets. RCM thus reduces the time to gather together a number of disparate firms in a targeted industry to critical mass because RCM results in direct transactions for all parties involved, reducing risk.

In an embodiment, a optimum acquisition valuation system has: means for determining a target industry; means for quantifying critical mass for IPO in the industry; means for determining acquisition targets in the industry; means for generating a three-stage offer for each target company within the acquisition targets; and means for organizing an entity formed of the acquisition targets as revenue neutral.

In an embodiment, a software product has instructions, stored on computer-readable media, wherein the instructions, when executed by a computer, perform steps of: determining a target industry; quantifying critical mass for IPO in the industry; determining acquisition targets in the industry; and generating a three-stage offer for each target company within the acquisition targets.

In an embodiment, an optimum acquisition valuation system has: an industry selector for determining a candidate industry for IPO; a target selector for automatically determining target companies within the industry; and a trend accumulator for automatically quantifying critical mass for an IPO.

### BRIEF DESCRIPTION OF DRAWINGS

FIG. 1 shows an optimum acquisition valuation system, in accord with an embodiment.

FIG. 2 shows an optimum acquisition valuation method, in accord with an embodiment.

### DETAILED DESCRIPTION OF DRAWINGS

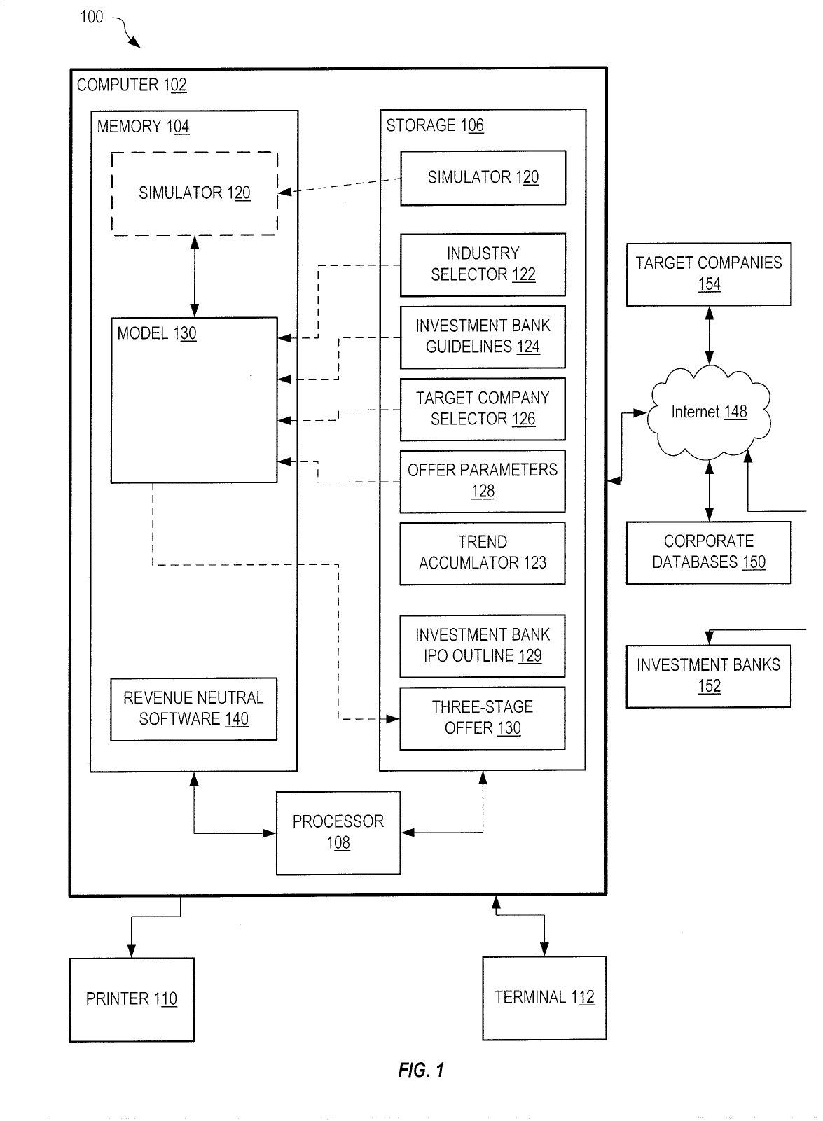

FIG. 1 shows one exemplary system 100 for implementing RCM. System 100 is shown with a computer 102 with memory 104, storage 106 and a processor 108. Optionally, computer 102 may connect to a printer 110 and a terminal 112. Memory 104 may be a volatile memory, such as provided by random access memory. Storage 106 may be a non-volatile storage such as provided by a disk drive.

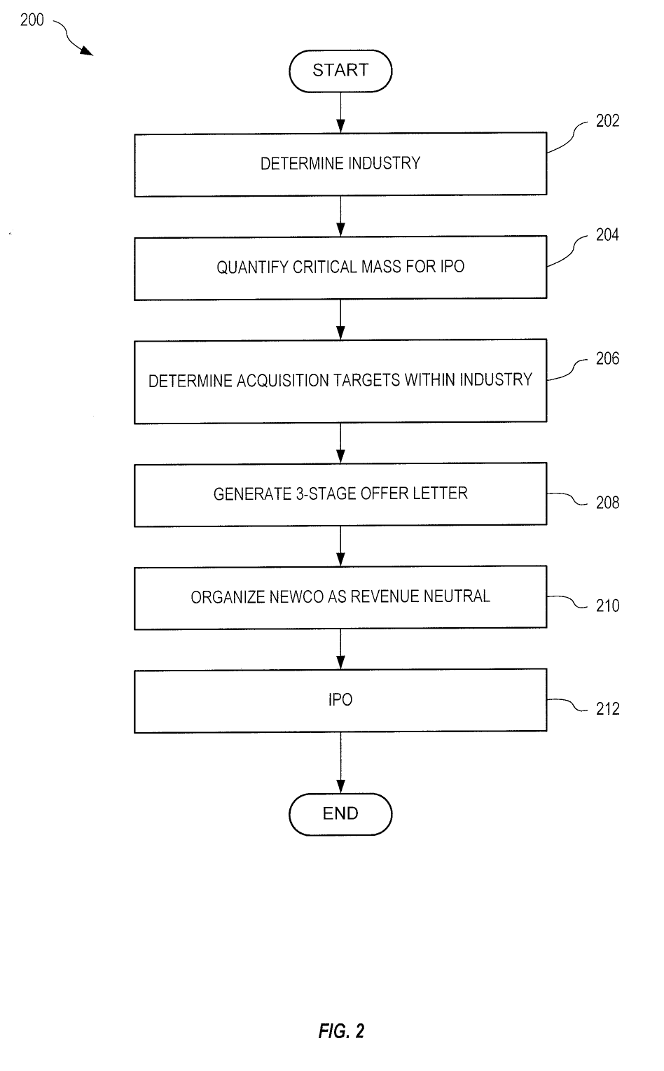

Storage 106 is shown with an IPO simulator 120, industry selector 122, trend accumulator 123, investment bank guidelines 124, target company selector 126, and offer parameters 128. In operation, processor 108 loads IPO simulator 120 into memory 104 (simulator 120 is shown in dashed outline within memory 104) and executes simulator 120. Simulator 120 generates a roll-up model 130 based upon input from investment bank guidelines 122, target selector 124, and offer parameters 126. Roll-up model 130 defines the parameters for investors (as investment bank IPO outline, step 204 of FIG. 2) and for each target company which is results in a three-stage offer 130. Trend accumulator 123 may for example conduct an automated search through Internet 148 and corporate databases 150 to establish IPO trends over a select period of time (e.g., as part of step 204, FIG. 2).

Computer 102 may connect directly to the Internet 148 which in turn may connect with corporate databases 150 (having information on target companies in any given industry), investment banks 152 as well as target companies 154. Investment banks 152 may populate guidelines 122 (or system 100 may automatically populate guidelines 122). Industry selector 122 scans databases 150 to determine target companies of a promising industry (see step 202, FIG. 2). Target company selector 126 scans and then reduces the set of target companies for inclusion in NewCo (e.g., as part of step 206, FIG. 2). Revenue neutral software 140 may for example enable automatic revenue allocations to each target company so that NewCo (in the form of an MLP) operates revenue neutrally (see step 210, FIG. 2).

FIG. 2 is a flowchart illustrating one exemplary method 200 for optimum acquisition valuation. Method 200 is for example implemented by system 100, FIG. 1; in particular software implementing model 130 may be a set of instructions implemented by processor 108 to perform steps of method 200. In step 202, an industry is determined. In an example of step 202, industry selector 122 canvases corporate databases 150 to isolate a candidate industry (e.g., funeral homes). In step 204, critical mass is quantified based on variables from investment bank guidelines 124. In an example of step 204, an outline 129 of the target industry is generated, with projected revenues, profits and cash flow and economies of scale of NewCo; this outline is usually sufficient for an investment bank to provide an estimate of the scale of revenues needed to reasonably pursue an IPO. Outline 129 is for example a statistical and quantitative analysis of the industry, and the 12, 24 and 36 month IPO history.

In step 206, acquisition targets within the industry are determined. In an example of step 206, target company selector 126 selects appropriate companies to form a set of companies in NewCo. For example, selector 126 rates companies into a set of companies according to profitability, years in business, size and experienced management.

In step 208, a three-stage offer letter 130 is generated; the letter for example sets forth how each TC is paid as a percentage of NewCo and how a TC can opt out at any of three stages.

In step 210, NewCo (in the form of a MLP generally) is operated revenue neutrally until, in step 212, an IPO commences.

Changes may be made in the disclosed RCM and optimum acquisition valuation system and methods without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. An optimum acquisition valuation system, comprising:
means for determining a target industry;
means for quantifying critical mass for IPO in the industry;
means for determining acquisition targets in the industry;
means for generating a three-stage offer for each target company within the acquisition targets; and
means for organizing an entity formed of the acquisition targets as revenue neutral.

2. The system of claim 1, the entity comprising a MLP.

3. The system of claim 1, wherein one or both of the means for determining a target industry and the means for determining acquisition targets comprise means for automatically utilizing online databases.

4. A software product comprising instructions, stored on computer-readable media, wherein the instructions, when executed by a computer, perform steps for:
determining a target industry;
quantifying critical mass for IPO in the industry;
determining acquisition targets in the industry; and
generating a three-stage offer for each target company within the acquisition targets.

5. The software product of claim 4, further comprising instructions for organizing an entity formed of the acquisition targets as revenue neutral.

7. An optimum acquisition valuation system, comprising:
an industry selector for determining a candidate industry for IPO;
a target selector for automatically determining target companies within the industry; and
a trend accumulator for automatically quantifying critical mass for an IPO.

8. The system of claim 7, further comprising an IPO simulator for simulating data from the industry selector, target selector and trend accumulator, to generate one or both of an investment bank IPO outline and a three-stage offer letter.

9. The system of claim 7, further comprising revenue neutral software for facilitating revenue neutral accounting of an entity formed of the acquisition targets.
